(19) United States
(12) Patent Application Publication
(10) Pub. No.: US 2018/0174162 A1
(43) Pub. Date: Jun. 21, 2018

(54) METHOD FOR PREDICTING USER PREFERENCE

(71) Applicant: INDUSTRIAL TECHNOLOGY RESEARCH INSTITUTE, Hsinchu (TW)

(72) Inventors: En-Tzu WANG, Kaohsiung City (TW); Tsung-Wen TSO, New Taipei City (TW)

(73) Assignee: INDUSTRIAL TECHNOLOGY RESEARCH INSTITUTE, Hsinchu (TW)

(21) Appl. No.: 15/391,478

(22) Filed: Dec. 27, 2016

(30) Foreign Application Priority Data
Dec. 16, 2016 (TW) 105141763

(51) Int. Cl. G06Q 30/02; G06Q 30/06

(52) U.S. Cl. CPC G06Q 30/0201; G06Q 30/0641

(57) ABSTRACT

A method for predicting user preference comprising: obtaining a users group with multiple users and a history shopping record associated with multiple goods; selecting a goods parameter, each goods having the goods parameter; selecting a plurality of first values of the goods parameter according to the history shopping record; determining a determining a representative users group with multiple representative users according to the history shopping record and the first values; calculating a correlation between a user and one of the representative users in the representative users group; and predicting the preference of the users according to the correlation and representative users' preference.

### CROSS-REFERENCE TO RELATED APPLICATIONS

This non-provisional application claims priority under 35 U.S.C. § 119(a) on Patent Application No(s). 105141763 filed in Taiwan, R.O.C. on Dec. 16, 2016, the entire contents of which are hereby incorporated by reference.

### TECHNICAL FIELD

The disclosure relates to a method for predicting user preference.

### BACKGROUND

Collaborative filtering is a general algorithm for filtering and screening information in different areas such as e-commerce. For example, in e-commerce, collaborative filtering algorithm is utilized to predict or estimate the preference, that what he or she would likely to by or is interested in, of a buyer based on his or her history purchasing behavior or on other buyers that have similar purchasing behavior, which could be seen as a recommendation service for individualized information or products, by using the preference of a group of people.

Other areas that are able to be applied with would be online media playing service, such as online music playing service or online video playing service. Both may be benefited from collaborative filtering algorithm to achieve the same purpose. One would be noticed is that, with the increasing of user numbers, not only products and service items increase as well, but also the data amount that collaborative filtering algorithm would be dealing with. An implication out of that is the processing time and memory for data increase as well.

### SUMMARY

According to an embodiment, a method for predicting user preference is disclosed. The method for predicting user preference comprises: obtaining a user group and a history shopping record of the user group, the history shopping record associated with a plurality of goods; selecting a goods parameter, each of the goods having the goods parameter; selecting a plurality of first values of the goods parameter according to the history shopping record; determining a user representative group from the user group according to the history shopping record and the first values, the user representative group including a plurality of representative users; calculating a correlation between a user and each of the representative users of the user representative group; and estimating a preference of the user according to the correlations and history shopping records of the representative users; wherein the user representative group comprises a representative group history shopping record, the representative group history shopping record covers a portion of the history shopping records, and the representative group history shopping record covers the first values.

According to another embodiment, an in-built programmable computer readable recording media is disclosed. When a computer loads a program and executes the program, the method for predicting user preference as claimed in the previous paragraph is performed.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view illustrating the method for predicting user preference according to an embodiment of the present disclosure;

FIG. 2 is a schematic view illustrating the flowchart of the method for predicting user preference according to an embodiment of the present disclosure; and

FIG. 3 is a schematic view illustrating the flowchart of selecting user representative group according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

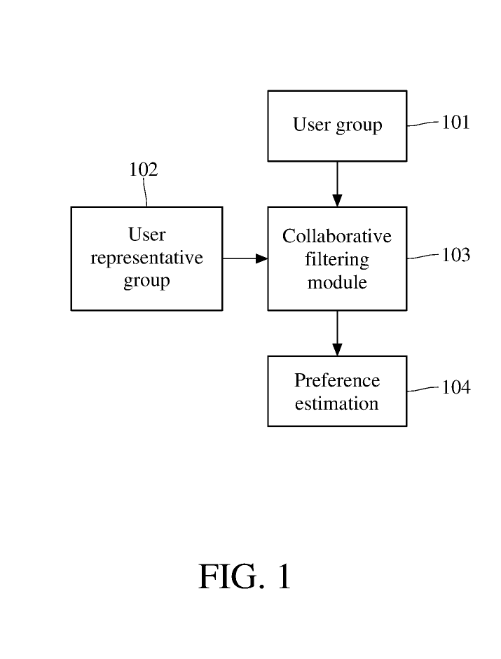

FIG. 1 is a schematic view illustrating the method for predicting user preference according to an embodiment of the present disclosure. In the present embodiment, a music service providing platform is taken as the example. The present disclosure would be limited only to a music service providing platform, many others like video service providing platform, multi-media service providing platform or online shopping platform. A person with ordinary skill in the art may refer to the present disclosure and make modifications to meet with different demands properties in other scenarios. As shown in FIG. 1, a user group 101 comprises all the users, which could be all the registered members of the music service providing platform.

User representative group 102 is composed of by selecting part of the users in the user group 101, and the users that are selected into the user representative group 102 are referred to as representative user. The users that are selected into the user representative group 102 are preferably to be heavy users of the music service providing platform. For example, heavy users may be those who listen to music for a long time, log in to the music service providing platform frequently or listen to different types of music. The way of selecting user representative group would not be limited only to above-mentioned listing time, logging in times or wide-ranging listeners, it may be modified to fit with different demands. The user representative group comprises a representative history shopping history recording all the music listening, playing and using records of the representative users.

The representative users in the user representative group are less than all the users in the user group in number, and the user representative group 102 would be used to represent the user group 101. That is to say, for a provider of a music service providing platform, the user groups 101 comprises all the users; the user group 101 may comprises heavy user, medium user, light users and all the playing records, which implies the data amount is enormous. In the present embodiment, the user representative group 102 is used to represent the user group 101, so as to decrease the data amount that would be processed because all the data is represented by partial data with less data amount but more important information.

Subsequently, the user group 101 and the user representative group 102 are all sent to a collaborative filtering module 103, and the collaborative filtering module 103 performs a collaborative filtering algorithm. In the present embodiment, the collaborative filtering algorithm computes a correlation between a user and a representative user. The way of how to calculate the correlation is not limited, it could be a correlation coefficient between a user and a representative user. However, a person with ordinary skill in the art could choose an appropriate method to calculate the correlation to fit for different requirement.

The collaborative filtering module 103, by the collaborative filtering algorithm, and based on the correlation, assign or recommend a preference record of a representative user to a user. The collaborative filtering module 103 would calculate the correlation between each of the user in the user group 101 and each of the representative user in the user representative group 102. After the correlation is obtained, then a representative user that has the highest correlation would be selected for representing the user, and the preference record of the representative user would be assign or recommend to the user (preference estimation 104), or to estimate the preference of the user according to the correlation and the preference of the representative user.

To be more specific, preference record may be, but not limit to, the music that the representative listen to frequently, the evaluation of certain music or singers, the singers that are followed. Further, the above mentioned to assign or recommend the preference record to the user may be, but not limited to, to recommend the music to the user that the representative user frequently listen to, to recommend the evaluation the representative user have on certain music or singers to the user, or to recommend the playing behavior of the representative user to the user.

What would be noticed is, in the present embodiment, the representative group history shopping record of the user representative group is greater or equal to a first ratio of the history shopping history. To be more specific, the representative group history shopping record may preferably to be, but not limited to, covering 90% (the first ratio) of the history shopping record.

The music service providing platform may classify all the users into several groups, based on their using to the platform, and as what was mention previously, it may be classified to heavy, medium and light user. The heavy user may have relatively more data amount in their history shopping record, and the light may have relatively less data amount in their history shopping record. Moreover, the history shopping record of the light user may be overlapping with the history shopping record of the heavy user. With the reasons listed above, to represent the history shopping record of all the users by using the history shopping record of the heavy user may help to decrease the data amount (the representative history shopping record covers 90% of the history shopping record). In that scenario, data with less information is discarded, the data that need to be processed decreased as well.

For example, please refer to the table 1 list below. The table 1 is a grouping list of goods parameter according an embodiment of the present disclosure. In the present embodiment, goods are songs, and goods parameter is name of singer. Thus, the name of singer A (e.g. Madonna) is a parameter, and the name of singer B (e.g. Justin Bieber) is another parameter. As shown in table 1, group 1 has the most parameters, however the history shopping record shows that the goods corresponding to the parameter is being purchased (times of listening) the least in average (being purchased 1.7 times in average). However, for group 10, it has the least parameters, but the history shopping record shows that the goods corresponding to the parameters is being purchased the most in average (being purchased 63677.19 times in average). For example, if all the songs of a singer C were purchased 70,000 times in a certain period in the past, then singer C belongs to group 10. Moreover, the parameters (singer) in the group 10 are the most popular singers and the parameters in the group 1 are the least popular singers. When selecting a candidate list of representative goods parameter (singer), all the goods parameters (singer) would be selected first, and then the goods (songs that has been played) corresponding to the singers in group 10 would be analyzed to determine whether all the goods of the history shopping record has been covered of 90%. If the answer is no, then all the singers in group 9 would then be selected, and added into the candidate list, and then the same analysis would be performed. All the singers in different groups would be added up, until all the songs corresponding to all the singers in total cover 90% of the songs in the history shopping record. What would be notice is, the above mentioned to cover 90% of the songs in the playing record means the covered play log. For example, in the history record, song S1 has been played 99 times and song S2 has been played just 1 time. Under that scenario, if the singer who sang the song S1 is selected, then 99% of the play log would be covered, however only 50% of the song would be covered (since song S2 is omitted).

TABLE 1

| Group No. | Number of Singers | Purchased in Average |
|---|---|---|
| 1 | 22900 | 1.7 |
| 2 | 8322 | 4.83 |
| 3 | 6477 | 8.7 |
| 4 | 7746 | 18.33 |
| 5 | 7300 | 55.58 |
| 6 | 3982 | 247.15 |
| 7 | 1799 | 1155.2 |
| 8 | 555 | 5392.7 |
| 9 | 222 | 21400.03 |
| 10 | 40 | 63677.19 |

Referring to table 1 once again, when the selection goes to group 3 (which means the singers from group 10 to group 3 are all added up), the goods corresponding to the parameters has covered 90% of the goods in the history shopping record. After that, the selected singer would be used to represent all the singers.

The 90% coverage would be limiting the scope of the present disclosure, a person with ordinary skill in the art may understand after referring to the specification, and may modify the ratio in order to meet different demands in different situations.

Subsequently, the representative user would be selected according the history shopping history and the selected first values. First, candidates for representative user would be selected. As shown in table 2, group 1 has the most users, but the history shopping record shows the user in that group has the least purchasing in average (purchasing 1.76 times in average). Group 18 has the lease users, but the history shopping record shows the user in that group has the most purchasing in average (purchasing 3131.89 times in average). That is to say, users in group 18 are the heaviest user, and users in group 1 are the lightest user. When selecting candidate list for representative user, all the users in group 18 would be selected first, and then the goods (songs that have been played) that are purchased by the users in group 18 would be analyzed to determine whether it covers all the selected parameters (singer) as mention previously. If the answer is no, then all the user in group 17 would then be selected and added into the candidate list (users in both group 17 and group 18 would be added up), and then the same analysis would be performed, until all the users in all the selected groups, by the time which means the goods purchased by the users have already covered all the selected singers.

TABLE 2

| Group No. | Number of Users | Purchased in Average |
|---|---|---|
| 1 | 32144 | 1.76 |
| 2 | 27310 | 6.2 |
| 3 | 21098 | 13.18 |
| 4 | 21306 | 23.1 |
| 5 | 17863 | 36.1 |
| 6 | 17344 | 52.15 |
| 7 | 14826 | 71.02 |
| 8 | 14390 | 93.2 |
| 9 | 13127 | 118.86 |
| 10 | 12413 | 149.35 |
| 11 | 12399 | 186.98 |
| 12 | 12444 | 236.79 |
| 13 | 12505 | 305.48 |
| 14 | 12193 | 409.63 |
| 15 | 10209 | 582.1 |
| 16 | 6409 | 987.16 |
| 17 | 2654 | 1553.38 |
| 18 | 620 | 3131.89 |

Referring to table 1 once again, when the selection goes to group 7 (which means the users from group 18 to group 16 are all added up), the goods purchased by the users has already covered all the selected singers. By that time, the selected user representative group would be used as candidate for user representative group. Take the example as described above, almost 300,000 users in total, the candidates selected from these users are only 10,000 left. And then, the user representative group would be selected from this 10,000 group.

What would be notice is, table 2 has 18 groups, which is classified by a listening range among the users of the user group. However, the basic for group classifying would not be limited by the range of song-listening (or listening range); it could also be based on a listening frequency of a user or a log in frequency of a user. Moreover, if a video playing service platform is taken as an example, the basis for classifying group may be a watching range among the users of the user group, a watching frequency of a user or a log in frequency of a user.

For each of the users (candidate users) of the candidate group (the above mentioned 10,000 group), assuming a goods (songs) purchased by the users correspond to 50-70 parameters (50-70 singers), and the 30 singers that the user purchased the most would be used as an eigenvalue for the user. The value of 30 is for exemplary description, and would not be limiting the scope of the present disclosure. Next, a user would be selected into the user representative group, where at this moment the corresponding parameters of the user representative group are in total 30. When selecting a next candidate into the user representative group, an overlapping degree between the parameters corresponding to each of the candidate and the current user representative group would be calculated first, and a candidate with the least overlapping degree would have the priority to be selected into the user representative group. Follow the principle, the progress of selection keeps going on, until the parameters corresponding to the user representative group cover all the selected parameters (singer). With this principle, the amount of the selected user representative group would be the least, which is convenient for the following computing.

In the present embodiment, the overlapping degree means that after selecting a user into the user representative group (as described previously, the corresponding parameters of the user representative group is in total 30), when selecting a next candidate into the user representative group, assuming 10 out of the corresponding parameters of a candidate A have already in the 30 parameters (which means the overlapping degree is 10), and 5 out of the corresponding parameters of a candidate B have already in the 30 parameters (which means the overlapping degree is 5), then candidate B would be selected into the user representative group.

In the present embodiment, collaborative filtering module 103 is a combined user-based and model-based collaborative filtering module. For user-based collaborative filtering, it is based on, after estimating two users (e.g. user X and user Y) that have similar using behavior (such as the users have similar preference), recommend user Y the using behavior of user X (or vice versa, recommend user X the using behavior of user Y). For model-based collaborative filtering, it is based on estimating a possible using behavior or a preference of a user according to history information (history shopping record).

What would be notice is, in the present embodiment, the above mentioned goods would not be limited to song, and it could also be movie, TV shows or other multi media.

Moreover, the goods parameter would not be limited to name of singer. For example, under the condition those goods is song, the goods parameters may be, but not limited to, the composer of the song, the producer of the song, or the issuing company of the song. For another example, under the condition that goods is movie, the goods parameter may be, but not limited to name of actor, the director of the movie, the producer of the movie, or the issuing company of the movie.

Furthermore, take the example as goods parameter is name of singer, then the goods parameter would be, as described previously, name of singer such as Madonna or Justin Bieber. But for the example as goods parameter is name of composer, then the parameters would be the name of some famous music composer such as Will Jennings (songwriter of My Heart Will Go On).

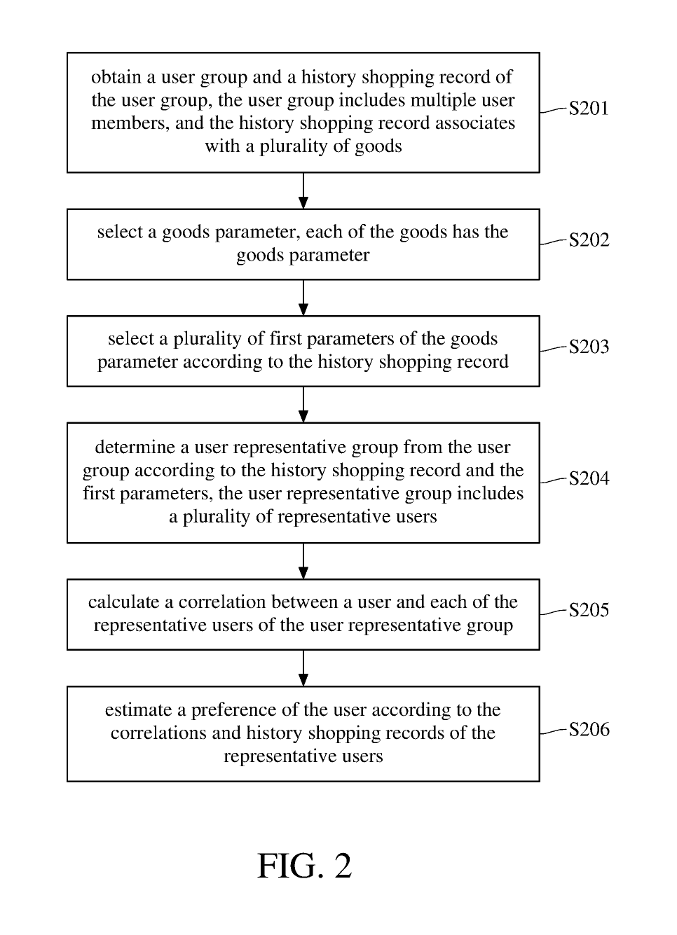

FIG. 2 is a schematic view illustrating the flowchart of the method for predicting user preference according to an embodiment of the present disclosure. In the present embodiment, music service providing platform is taken as an example. As shown in FIG. 2, in step S201, obtain a user group and a history shopping record of the user group, the user group includes multiple user members and the history shopping record associates with a plurality of goods. The user members are the registered users for the music service providing platform, and the history shopping record records the using behaviors of all the users of the platform (such as times of logging in, timing of logging in, songs that have been played or listened). Moreover, in the present, the goods are the songs.

Next, in step S202, select a goods parameter, each of the goods has the goods parameter. In the present embodiment, the goods parameter is the name of singer.

Subsequently, in step S203, select a plurality of first values of the goods parameter according to the history shopping record. For the goods parameter, as described previously, Madonna (the name of a signer) is a parameter, Justin Bieber (the name of a signer) is a parameter.

In step S204, determine a user representative group from the user group according to the history shopping record and the first values, the user representative group includes a plurality of representative users. The method of determining a user representative group from the user group could be referred to from the above description (such as table 1, table 2 and the relative description).

In step S205, calculate a correlation between a user and each of the representative users of the user representative group. And in step S206, estimate a preference of the user according to the correlations and history shopping records of the representative users. The user representative group includes a representative group history shopping record, and the representative group history shopping record covers a portion of the history shopping record. Moreover, the representative group history shopping record covers the first values.

What would be notice is, in step S206, it is performed based on a user-based collaborative filtering and a model-based collaborative filtering. For user-based collaborative filtering, it is based on, after estimating two users that have similar using behavior, recommend one of the users the using behavior of the other one user. For model-based collaborative filtering, it is based on estimating a possible using behavior or a preference of a user according to history information (history shopping record).

What would be notice is the method for calculating the correlation and the form of the correlation are not limited. The correlation could be a correlation coefficient between a user and a representative user. However, a person with ordinary skill in the art could choose an appropriate method to calculate the correlation to fit for different requirement.

Moreover, the preference may comprise, but not limited to, the music the representative users listen to frequently, the status of a singer that the representative users is following. Further, assigning a preference record of a representative user to a user may comprise, but not limited to, recommend the user the music that the representative user listen to frequently, recommend the user the evaluation of certain music or singers made by the representative users, or recommend the user the playing behavior of the representative users.

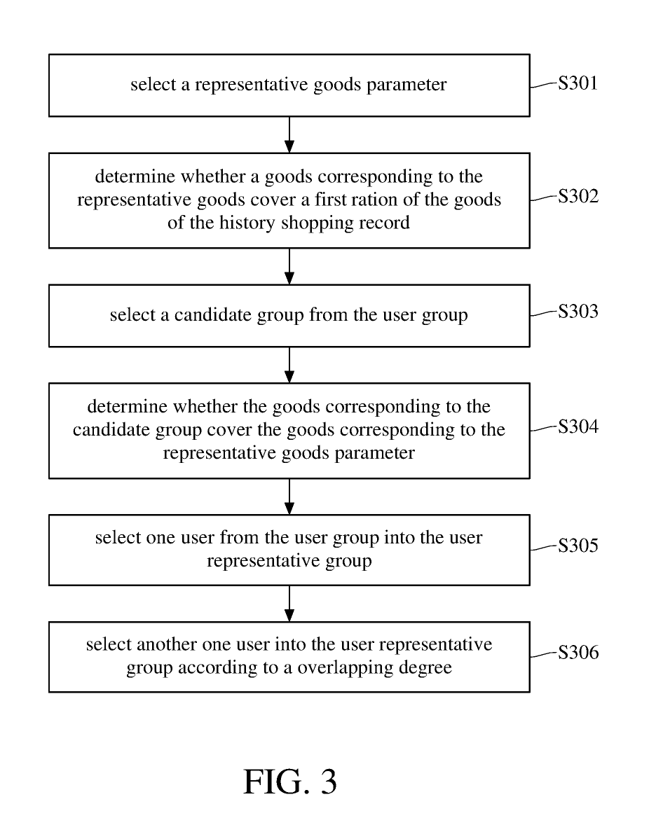

FIG. 3 is a schematic view illustrating the flowchart of selecting user representative group according to an embodiment of the present disclosure. As shown in FIG. 3, in step S301, select a representative goods parameter and in step S302, determine whether a goods corresponding to the representative goods cover a first ratio of the goods of the history shopping record. The related description could be referred to as the description of table 1.

In step S303, select a candidate group from the user group and in step S304, determine whether the goods corresponding to the candidate group cover the goods corresponding to the representative goods parameter. The related description could be referred to as the description of table 2.

Last, in step S205, select one user from the user group into the user representative group and in step S206, select another one user into the user representative group according to an overlapping degree. Please refer to the previous paragraphs for the detail description on the overlapping degree.

An in-built programmable computer readable recording media is also disclosed in the present disclosure. When a computer loads a program and executes the program, the method for predicting user preference as claimed in the previous paragraph is performed.

What is claimed is:

1. A method for predicting user preference, comprising:
obtaining a user group and a history shopping record of the user group, the history shopping record associated with a plurality of goods;
selecting a goods parameter, each of the goods having the goods parameter;
selecting a plurality of first values of the goods parameter according to the history shopping record;
determining a user representative group from the user group according to the history shopping record and the first values, the user representative group including a plurality of representative users;
calculating a correlation between a user and each of the representative users of the user representative group; and
estimating a preference of the user according to the correlations and history shopping records of the representative users;
wherein the user representative group comprises a representative group history shopping record, the representative group history shopping record covers a portion of the history shopping records, and the representative group history shopping record covers the first values.

2. The method for predicting user preference as claimed in claim 1, wherein the step of determining a user representative group from the user group according to the history shopping record and the first values, the user representative group including a plurality of representative users comprises:
selecting a representative goods parameter;
determining whether a goods corresponding to the representative goods parameter cover a first ratio of the goods of the history shopping record;
selecting a candidate group from the user group;
determining whether the goods corresponding to the candidate group cover the goods corresponding to the representative goods parameter;
selecting one user from the user group into the user representative group; and
selecting another one user into the user representative group according to an overlapping degree.

3. The method for predicting user preference as claimed in claim 2, wherein the step of selecting one user from the user group into the user representative group comprises:
selecting a candidate user into the candidate group according to a listening range of the user group.

4. The method for predicting user preference as claimed in claim 3, wherein the user group comprises a plurality of user members, and the step of selecting one user from the user group into the user representative group comprises:
selecting a candidate user into the candidate group according to a listening range, a listening frequency or a log in frequency of the user group.

5. The method for predicting user preference as claimed in claim 2, wherein the step of selecting one user from the user group into the user representative group comprises:
selecting a candidate user into the candidate group according to a watching range of the user group.

6. The method for predicting user preference as claimed in claim 5, wherein the user group comprises a plurality of user members, and the step of selecting one user from the user group into the user representative group comprises:
selecting a candidate user into the candidate group according to a watching range, a watching frequency or a log in frequency of the user group.

7. The method for predicting user preference as claimed in claim 1, wherein the step of estimating a preference of the user according to the correlations and history shopping records of the representative users is based on a user-based collaborative filtering.

8. The method for predicting user preference as claimed in claim 1, wherein the step of estimating a preference of the user according to the correlations and history shopping records of the representative users is based on a model-based collaborative filtering.

9. The method for predicting user preference as claimed in claim 1, wherein the goods parameter is name of singer.

10. The method for predicting user preference as claimed in claim 1, wherein the goods parameter is name of actor.

11. An in-built programmable computer readable recording media, when a computer loads a program and executes the program, the method for predicting user preference as claimed in claim 1 is performed.
